(19) United States
(12) Patent Application Publication
(10) Pub. No.: US 2006/0050920 A1
(43) Pub. Date: Mar. 9, 2006

(54) Condenser microphone unit

(75) Inventor: Hiroshi Akino, Machida-shi (JP)

Correspondence Address: KANESAKA BERNER AND PARTNERS LLP, SUITE 300, 1700 DIAGONAL RD, ALEXANDRIA, VA, 22314-2848, US

(73) Assignee: KABUSHIKI KAISHA AUDIO-TECHNICA, Machida-shi (JP)

(21) Appl. No.: 11/204,091

(22) Filed: Aug. 16, 2005

(30) Foreign Application Priority Data
Aug. 18, 2004 (JP) 2004-238263

(51) Int. Cl. H04R 11/02

(52) U.S. Cl. 381/396

(57) ABSTRACT

The resonance frequency of a diaphragm in a condenser microphone unit is increased without applying an excessive tension to the diaphragm and without decreasing the effective electrostatic capacity. In a condenser microphone unit in which a diaphragm assembly 100 having a diaphragm 120 stretchedly provided on a diaphragm support 110 under a predetermined tension and a backplate are arranged via a spacer so as to face to each other, a plurality of opening portions 111 which allow the diagram 120 to vibrate partially are formed in the diaphragm support 110.

### TECHNICAL FIELD

The present invention relates to a condenser microphone unit and, more particularly, to a technique for setting a resonance frequency of an audio machine vibration system rather high.

### BACKGROUND ART

As described in, for example, Patent Document 1 (Japanese Patent Application Publication No. H02-237300) and as schematically shown in FIG. 3, a condenser microphone unit includes, as a basic configuration, a diaphragm assembly 10 in which a diaphragm 12 is stretchedly provided on a metallic diaphragm support 11 under a predetermined tension and a backplate 20 having, for example, an electret membrane, these two elements being arranged via a spacer ring 30 so as to face to each other.

FIG. 4A is a front view of the diaphragm assembly 10, and FIG. 4B is an exploded central sectional view thereof. As seen from these figures, a support ring formed into a ring shape is used as the diaphragm support 11, and the peripheral edge portion of the diaphragm 12 is bonded to the support ring with an adhesive under the predetermined tension. Therefore, the whole area inside the support ring of the diaphragm 12 operates as an effective vibration portion (effective electrostatic capacity portion between the diaphragm 12 and the backplate 20).

In a non-directional microphone and a line microphone of the condenser microphones, it is necessary to increase the resonance frequency of the diaphragm 12. That is to say, since the control system of the non-directional microphone is elastic control, the resonance frequency of the diaphragm 12 is adjusted to a frequency close to a high frequency limit.

Also, in the line microphone, since a slender interfering sound tube is connected in front of the diaphragm 12, the frequency response in a low frequency region is liable to increase. In particular, since this tendency becomes remarkable as the length of sound tube increases, the frequency response in a low frequency region is made flat by increasing the tension of the diaphragm.

Usually, as the diaphragm 12 of the condenser microphone, a thin film produced by forming a metalized membrane on a polymer film is used. However, this thin film has a problem in that if a high tension is applied to the diaphragm 12 of this type for the above-described purpose, plastic deformation (creep) occurs, so that a tension proportional to the applied stress cannot be obtained.

Also, it is known that the self-noise of condenser microphone decreases as the effective electrostatic capacity of microphone unit increases. On the other hand, the resonance frequency of the diaphragm 12 becomes difficult to increase as the vibration area thereof increases.

### SUMMARY OF THE INVENTION

Accordingly, a problem of the present invention is to increase the resonance frequency of a diaphragm in a condenser microphone unit without applying an excessive tension to the diaphragm and without decreasing the effective electrostatic capacity.

To solve the above problem, the invention provides a condenser microphone unit in which a diaphragm assembly having a diaphragm stretchedly provided on a diaphragm support under a predetermined tension and a backplate are arranged via a spacer so as to face to each other, wherein a plurality of opening portions which allow the diagram to vibrate partially are formed in the diaphragm support.

According to this invention, by stretchedly providing the diaphragm on the diaphragm support, which has the opening portions that allow the diagram to vibrate partially, under the predetermined tension, even if a high tension is not applied to the whole of diaphragm, the resonance frequency of an audio machine vibration system in the condenser microphone unit can be increased.

Thereby, in a non-directional condenser microphone, the sound absorption limit in a high frequency region can be expanded to a high frequency. Also, in a line condenser microphone (gun microphone), the frequency response in a low frequency region can be made flat.

In increasing the effective vibration area of the diaphragm as far as possible within the diaphragm support with a limited area, according to the best mode of the present invention, the opening portion is of a hexagonal shape and seven opening portions are included in the diaphragm support, the seven opening portions being arranged so that one of the opening portions is located in the center of the diaphragm support and the remaining six opening portions are located around the central opening portion.

This configuration is equivalent to a plurality of diaphragms with high resonance frequency each having a small area connected in parallel electrically, so that the effective electrostatic capacity increases as a whole. Therefore, self-noise peculiar to the condenser microphone can be decreased.

As another mode, the opening portions each may be of a fan shape formed by dividing an imaginary round into equal parts. This configuration also solves the above-described problem. Also, the present invention embraces a line microphone and a non-directional microphone having the condenser microphone unit configured as described above.

According to the present invention, since the tension of diaphragm is high in terms of equivalence, the electrostatic adsorption stability between the diaphragm and the backplate can be increased. This means the capability of increasing the polarization voltage, and thereby a condenser microphone, especially a non-directional microphone and a line microphone, with high sensitivity and a proper S/N ratio can be provided.

### BRIEF DESCRIPTION OF THE DRAWINGS

FIG. 1A is a front view showing a diaphragm assembly that a condenser microphone unit in accordance with the present invention has;

FIG. 1B is an exploded central longitudinal sectional view of the diaphragm assembly shown in FIG. 1A;

FIG. 2A is a front view showing a first modification of an opening portion provided in a diaphragm support;

FIG. 2B is a front view showing a second modification of an opening portion provided in a diaphragm support;

FIG. 3 is a sectional view showing a basic configuration of a condenser microphone unit;

FIG. 4A is a front view showing a diaphragm assembly that a conventional condenser microphone unit has; and

FIG. 4B is an exploded central longitudinal sectional view of the diaphragm assembly shown in FIG. 4A.

### DETAILED DESCRIPTION

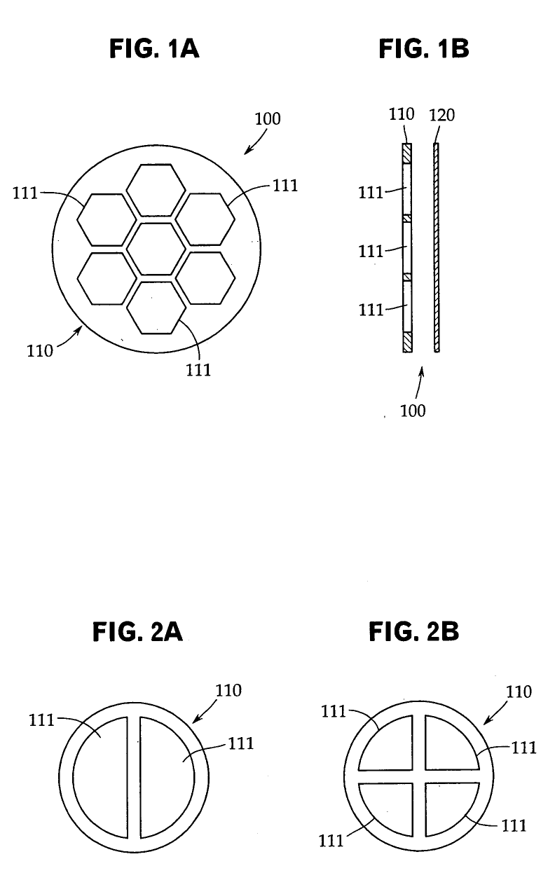

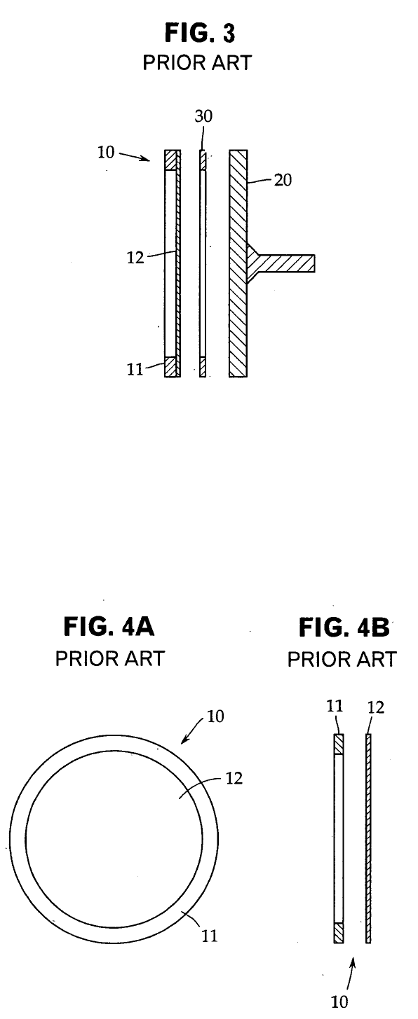

An embodiment of the present invention will now be described with reference to FIGS. 1A and 1B and FIGS. 2A and 2B. The present invention is not limited to the embodiment described below. In the present invention as well, the basic configuration of a condenser microphone unit, namely, an opposed arrangement of a diaphragm assembly and a back plate via a spacer ring can be the same as that in the conventional example having been explained with reference to FIG. 3. Therefore, the configuration of the diaphragm assembly, which is a feature of the present invention, is exclusively explained hereunder.

FIG. 1A is a front view of the most favorable diaphragm assembly 100 that the condenser microphone unit in accordance with the present invention has. FIG. 1B is a central sectional view of FIG. 1A, showing a state in which a diaphragm support 110 and a diaphragm 120, which are included in the diaphragm assembly 100, are separated.

As the diaphragm support 110, a metallic disc element is used. The material thereof may be selected from brass alloy and aluminum, for example. The size thereof may be designed arbitrarily, and as one example, the diameter thereof is usually 16 to 20 mm in the case of a small-size unit.

The diaphragm 120 is bonded to the diaphragm support 110 with a suitable adhesive under a predetermined tension. In the case of the application of condenser microphone unit to a non-directional microphone or a line microphone, it is necessary to increase the resonance frequency of the diaphragm 120.

In the present invention, therefore, a plurality of opening portions 111 are provided in the diaphragm support 110 to allow the diaphragm 120 to vibrate partially. The shape and number of the opening portions 111 are determined depending on the degree to which the resonance frequency of the diaphragm 120 is increased. Regarding the shape thereof, a polygon is better than a circle in order to increase the effective vibration area of the diaphragm 120 as far as possible within the limited area of the diaphragm support 110.

In an example shown in FIG. 1, as the most favorable mode, the shape of the opening portion 111 is made a regular hexagon, and seven hexagonal opening portions are arranged in the diaphragm support 110. Specifically, one of the opening portions is arranged in the center of the diaphragm support, and the remaining six opening portions are arranged around the central opening portion.

By bonding the diaphragm 120 to the diaphragm support 110 under the predetermined tension, a diagram with high resonance frequency having a small area is produced for each of the opening portions 111, which is equivalent to these small diaphragms connected in parallel electrically.

Therefore, the resonance frequency of an audio machine vibration system can be increased, and also electrically, the effective electrostatic capacity is high, so that self-noise peculiar to the condenser microphone can be decreased. As the diaphragm 120, a polymer film, for example, produced by the vacuum deposition of a metal may be used. However, according to the present invention, such a high tension that creep occurs on the polymer film need not be applied to increase the resonance frequency of the diaphragm 120.

As another example, as shown in FIGS. 2A and 2B, the opening portion 111 may be of a fan shape. FIG. 2A shows an example in which two fan-shaped opening portions 111, which are formed by dividing an imaginary round into two equal parts, are provided in the diaphragm support 110. FIG. 2B shows an example in which four fan-shaped opening portions 111, which are formed by dividing an imaginary round into four equal parts, are provided in the diaphragm support 110.

In addition, the opening portion 111 includes many modifications; for example, a triangle or a pentagon can be adopted as the shape of the opening portion. Also, the opening portion provided in the diaphragm support 110 need not have the same shape and the same size, and the diaphragm support 110 may include opening portions 111 of a different shape.

The present application is based on, and claims priority from, Japanese Application Serial Number JP2004-238263, filed Aug. 18, 2004, the disclosure of which is hereby incorporated by reference herein in its entirety.

1. A condenser microphone unit in which a diaphragm assembly having a diaphragm stretchedly provided on a diaphragm support under a predetermined tension and a backplate are arranged via a spacer so as to face to each other, wherein a plurality of opening portions which allow the diagram to vibrate partially are formed in the diaphragm support.

2. The condenser microphone unit according to claim 1, wherein the opening portion is of a hexagonal shape and seven opening portions are included in the diaphragm support, the seven opening portions being arranged so that one of the opening portions is located in the center of the diaphragm support and the remaining six opening portions are located around the central opening portion.

3. The condenser microphone unit according to claim 1, wherein the opening portions each have a fan shape formed by dividing an imaginary round into equal parts.

4. A line microphone having the condenser microphone unit according to claim 1.

5. A non-directional microphone having the condenser microphone unit according to claim 1.
